(19) United States
(12) Patent Application Publication
(10) Pub. No.: US 2023/0081208 A1
(43) Pub. Date: Mar. 16, 2023

(54) MULTIFUNCTIONAL CHILDREN'S RIDE-ON VEHICLE

(71) Applicant: Shenzhen COOGHI Funkids Technology Co., Ltd, Shenzhen (CN)

(72) Inventor: Hong ZHANG, Zhaotong (CN)

(21) Appl. No.: 17/586,812

(22) Filed: Jan. 28, 2022

(30) Foreign Application Priority Data
Sep. 15, 2021 (CN) 202111082717.1

(51) Int. Cl. B62K 13/04; B62M 1/36; B62K 9/02; B62M 11/00; B62J 1/00

(52) U.S. Cl. CPC B62K 13/04; B62M 1/36; B62K 9/02; B62M 11/00; B62J 1/00

(57) ABSTRACT

The present disclosure provides a multifunctional children's ride-on vehicle including a frame, a vehicle head, a front wheel, pedal mechanisms, a rear frame, a seat, rear wheel brackets, rear wheels, and a push rod. The frame is provided with a plurality of adjusting grooves, and the plurality of adjusting grooves are evenly distributed along the frame. The rear frame is provided with an adjusting block corresponding to the adjusting groove, and the adjusting block is embedded into the adjusting grooves. The frame is provided with a frame accommodating groove at the front end thereof, and the frame accommodating groove has a size same as that of the adjusting groove.

### CROSS REFERENCE TO RELATED APPLICATION

The present disclosure claims priority to Chinese Patent Application No. 202111082717.1, filed Sep. 15, 2021, which is hereby incorporated by reference herein as if set forth in its entirety.

### BACKGROUND

### 1. Technical Field

The present disclosure relates to the field of children's vehicles, and particularly to a multifunctional children's ride-on vehicle.

### 2. Description of Related Art

Children's vehicles have become an indispensable product in the growth process of children. Children's vehicles generally include tricycle and bicycle. When children are younger, they usually ride tricycles when playing due to their lack of ability to master balance, so as to ensure safety. When children grow up, they are generally no longer interested in tricycles, but are more willing to ride two-wheeled bicycles. Therefore, at different growth stages of children, it is necessary to purchase different types of children's vehicles, which increases the cost of living. Moreover, children's vehicles on the current market are generally large in size, and may occupy a large space for storage when not in use. In addition, because the children have poor judgment capability on dangerous conditions, if children are allowed to play by themselves and parents cannot obtain the control of the children's vehicles, safety accidents are easy to happen.

Therefore, the prior art has shortcomings and needs improvement.

### BRIEF DESCRIPTION OF THE DRAWINGS

In order to more clearly illustrate the technical solutions in this embodiment disclosure, the drawings used in the embodiments or the description of the prior art will be briefly introduced below. It should be understood that, the drawings in the following description are only examples of the present disclosure. For those skilled in the art, other drawings can be obtained based on these drawings without creative works.

FIG. 1 is a schematic view of a multifunctional children's ride-on vehicle according to the present disclosure.

FIG. 2 is a schematic view of a bottom of a frame according to the present disclosure.

FIG. 3 is a schematic view of a ride-on vehicle in a storage state according to the present disclosure.

FIG. 4 is a schematic view of a push rod and a vehicle head according to the present disclosure.

FIG. 5 is a schematic view of a connecting portion of a push rod and a frame according to the present disclosure.

FIG. 6 is a schematic view of a pedal mechanism according to the present disclosure.

FIG. 7 is a sectional view of a connecting portion of a pedal mechanism and a clutch mechanism according to the present disclosure.

FIG. 8 is a schematic view of a rear frame and a rear wheel bracket according to the present disclosure.

FIG. 9 is a schematic view of a ride-on vehicle in a two-wheeled riding mode according to the present disclosure.

### DETAILED DESCRIPTION

In order to make the objectives, technical solutions, and advantages of the present disclosure clearer, the present disclosure will be further described in detail below with reference to the drawings and embodiments. It should be understood that, the embodiments described herein are only for explaining the present disclosure and are not intended to limit the present disclosure.

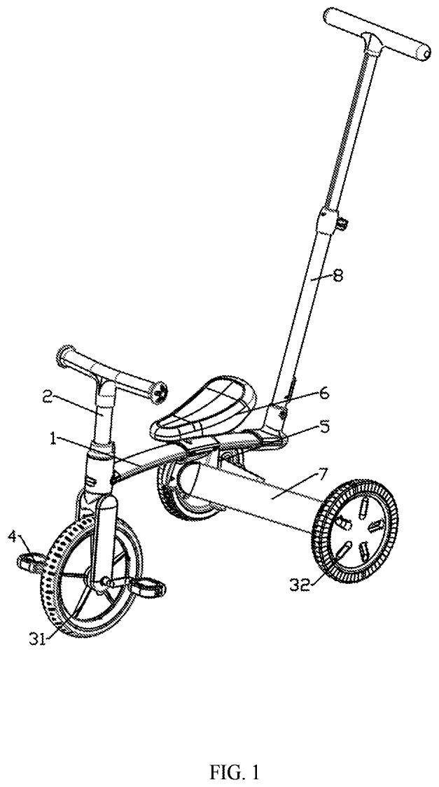

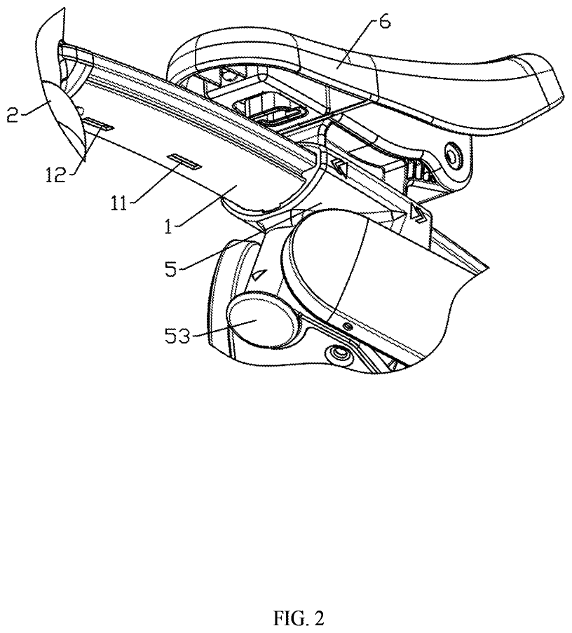

Referring to FIG. 1 to FIG. 2, the present disclosure provides a multifunctional children's ride-on vehicle, which includes a frame 1, a vehicle head 2 arranged at a front end of the frame 1, a front wheel 31 rotatably connected to the vehicle head 2, pedal mechanisms 4 connected to the front wheel 31, a rear frame 5 movably arranged on the frame 1, a seat 6 arranged on the rear frame 5, rear wheel brackets 7 respectively hinged to two sides of the rear frame 5, rear wheels 32 arranged on the rear wheel brackets 7, and a push rod 8 arranged at a rear end of the frame 1. The frame 1 is provided with a plurality of adjusting grooves 11, and the adjusting grooves 11 are evenly distributed along the frame 1. The rear frame 5 is provided with an adjusting block corresponding to the adjusting groove 11, and the adjusting block is embedded into the adjusting grooves 11. The frame 1 is provided with a frame accommodating groove 12 at the front end thereof, and the frame accommodating groove 12 has a size same as that of the adjusting groove 11.

When a child plays with the ride-on vehicle, the child can sit on the seat 6, and put feet on the pedal mechanisms 4 to drive the front wheel 31 to rotate, thereby driving the ride-on vehicle to move forward. In the process of moving forward, the forward direction of the ride-on vehicle can be adjusted through the vehicle head 2 to achieve steering. Meanwhile, the guardian can push the ride-on vehicle to move forward through the push rod 8, so that the forward direction of the ride-on vehicle can be controlled, and danger caused by the fact that children do not pay attention to the road condition is avoided. When a child grows tall and uncomfortable to sit on the ride-on vehicle, the relative position of the rear frame 5 on the frame 1 can be adjusted, the adjusting groove 11 corresponding to the proper position can be selected, so that the adjusting block of the rear frame 5 is embedded into the adjusting groove 11, thereby achieving the adjustment of the position of the seat 6.

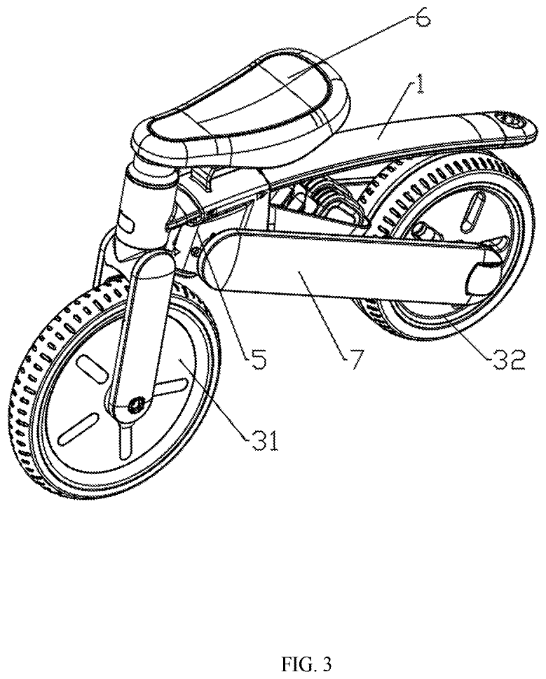

Referring to FIG. 3, when the ride-on vehicle needs to be stored, the rear frame 5 can be moved to corresponding position of the frame accommodating groove 12, so that the adjusting block can be embedded in the frame accommodating groove 12. In addition, the rear wheel brackets 7 at both sides are approached inward, and the vehicle head 2, the pedal mechanisms 4, and the push rod 8 are removed in sequence, so as to reduce the footprint of the ride-on vehicle and facilitate storage.

The rear frame 5 is provided with an adjusting button 53 at the bottom thereof, and the adjusting button 53 is connected with the adjusting block. When the adjusting button 53 is pressed, the adjusting block is driven to be separated from the adjusting groove 11 or the frame accommodating groove 12. The adjusting block is separated from the adjusting groove 11 or the frame accommodating groove 12 by pressing the adjusting button 53, and after the adjusting button 53 is released, the adjusting block is embedded into the adjusting groove 11 or the frame accommodating groove 12 corresponding to the adjusted adjusting block again, so that the relative position between the rear frame 5 and the frame 1 can be adjusted.

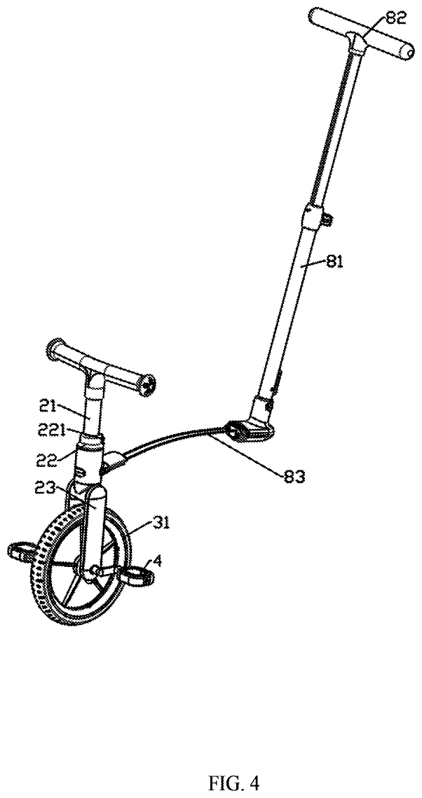

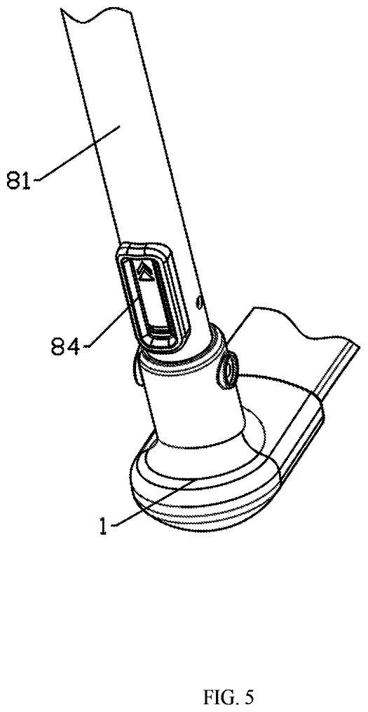

Referring to FIG. 4 and FIG. 5, the push rod 8 includes a telescopic rod 81, a push handle 82 arranged at a top end of the telescopic rod 81, a push rod connecting block arranged at a bottom of the telescopic rod 81, a frame connecting block arranged at the rear end of the frame 1, and a transmission belt 83 sleeved on the frame connecting block and the vehicle head 2. The push rod connecting block is embedded into the frame connecting block. When the push handle 82 is turned left and right, the vehicle head 2 is driven to rotate left and right through the transmission belt 83, so that the guardian can control the forward direction of the ride-on vehicle conveniently, and danger caused by poor judgment of children can be avoided. The telescopic rod 81 is provided with a push rod lock 84, and the push rod lock 84 is connected with the push rod connecting block. By pulling the push rod lock 84, the push rod connecting block is separated from the frame connecting block, so that the push rod 8 can be quickly assembled and disassembled.

The vehicle head 2 includes a vehicle head connecting block 22 connected with the frame 1, a front handlebar 21 passing through the vehicle head connecting block 22, and a front fork 23 connected with the front handlebar 21. The front handlebar 21 and the front fork 23 are arranged at an upper end and a lower end of the vehicle head connecting block 22, respectively. The front wheel 31 is rotatably connected to the front fork 23. The pedal mechanisms 4 are disposed on both ends of the front wheel 31 passing through the front fork 23.

The vehicle head connecting block 22 is provided with vehicle head adjusting holes. The front handlebar 21 is provided with a plurality of vehicle head adjusting blocks corresponding to the vehicle head adjusting holes. The vehicle head connecting block 22 is provided with a vehicle head adjusting button 221 corresponding to the vehicle head adjusting blocks. The vehicle head adjusting button 221 is connected with a reset mechanism. The vehicle head adjusting block is embedded into the vehicle head adjusting hole. By pressing the vehicle head adjusting button 221, the vehicle head adjusting block is separated from the vehicle head adjusting hole, so as to adjust the height of the front handlebar 21. After the vehicle head adjusting button 221 is released, the vehicle head adjusting button 221 can be reset under the action of the reset mechanism, so that the force applied to the vehicle head adjusting block is removed, the vehicle head adjusting block is embedded into the vehicle head adjusting hole, so as to fix the height position of the front handlebar 21, and complete the height adjustment of the front handlebar 21.

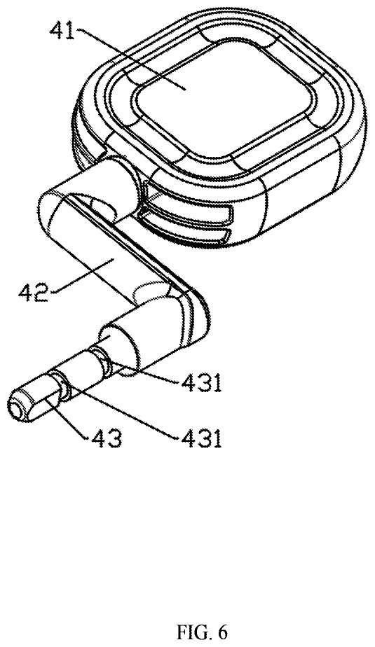

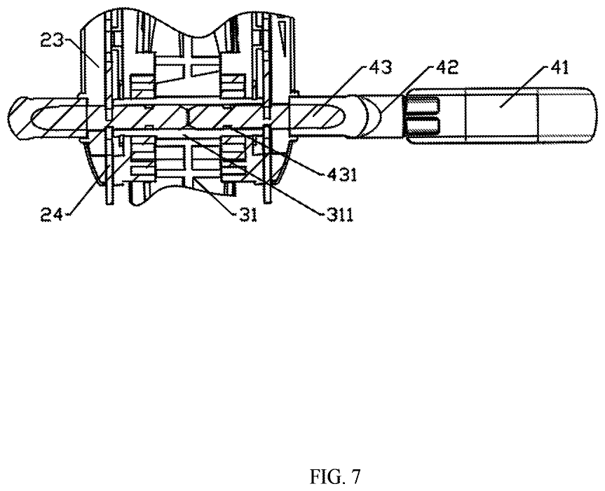

Referring to FIG. 6 to FIG. 7, the pedal mechanism 4 includes a pedal 41, a crank 42 rotatably connected to the pedal 41, and a connecting shaft 43 disposed at an end of the crank 42. The front wheel 31 is provided with a rotating shaft 311, and the connecting shaft 43 is embedded in the rotating shaft 311. Clutch mechanisms 24 are provided on both sides of the front fork 23 corresponding to the pedal mechanisms 4, respectively. The connecting shaft 43 is provided with two clutch gear grooves 431 corresponding to the clutch mechanisms 24, and the clutch mechanisms 24 are embedded into the clutch gear grooves 431. The clutch mechanism 24 is separated from the clutch gear groove 431 by pulling the clutch mechanism 24, then the pedal mechanism 4 is pulled outwards to separate the connecting shaft 43 from the rotating shaft 311, and then the clutch mechanism 24 is released, so that the clutch mechanism 24 is embedded into the clutch gear groove 431 close to the rotating shaft 311, and thus the connection between the pedal mechanism 4 and the front wheel 31 is cut off. At this case, even if the pedal mechanism 4 is stepped on by a foot to rotate the pedal mechanism 4, the front wheel 31 cannot be driven to rotate, so that the control right of the ride-on vehicle is delivered to the guardian who controls the push rod 8, and dangerous situations caused by poor judgment ability of children can be avoided. Similarly, the clutch mechanism 24 is pulled to separate the clutch mechanism 24 from the clutch gear groove 431, then the pedal mechanism 4 is pushed inwards to enable the connecting shaft 43 to be embedded into the rotating shaft 311, then the clutch mechanism 24 is released, so that the clutch mechanism 24 is embedded into the clutch gear groove 431 away from the rotating shaft 311, and thus the connection between the pedal mechanism 4 and the front wheel 31 is connected, and the control right is delivered to a child riding on the ride-on vehicle to be played by the child.

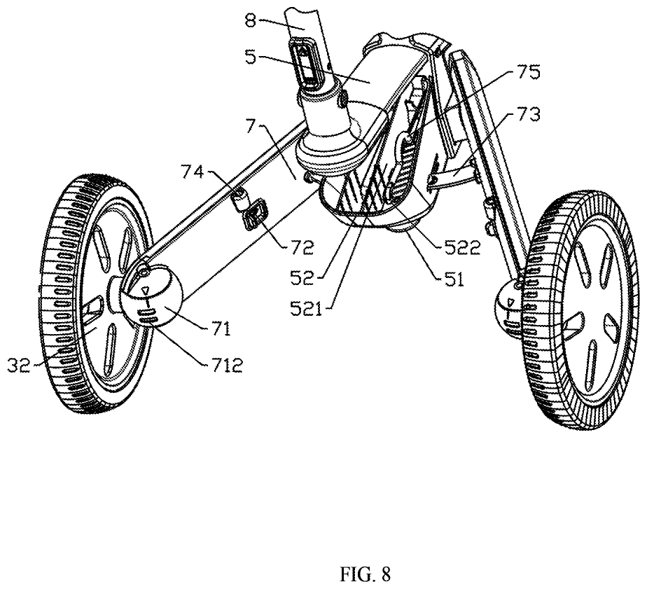

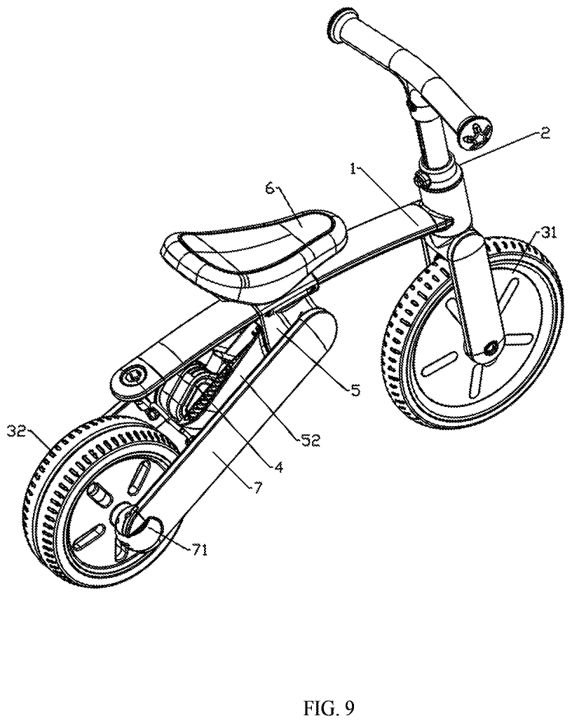

Referring to FIG. 8 and FIG. 9, a rear wheel rotating block 71 is hinged on the rear wheel bracket 7, the rear wheel 32 is rotatably arranged on the rear wheel rotating block 71, and the rear wheel 32 rotates left and right around the rear wheel rotating block 71. When the rear wheel bracket 7 is rotated inwards through the hinged position between the rear wheel bracket 7 and the rear frame 5 and the rear wheel brackets 7 on both sides are brought close to each other, the rear wheel rotating blocks 71 can be adjusted, so that the rear wheels 32 on both sides are overturned inwards and are close to each other, thereby transforming the three-wheeled ride-on vehicle into a two-wheeled ride-on vehicle to meet the different needs of children for play. Similarly, when the two-wheeled ride-on vehicle needs to be transformed into the three-wheeled ride-on vehicle, and when the rear wheel bracket 7 is rotated outwards through the hinged position between the rear wheel bracket 7 and the rear frame 5, and the rear wheel brackets 7 on both sides are brought far away from each other, the rear wheel rotating blocks 71 can be adjusted, so that the rear wheels 32 on both sides are overturned outwards and are far away from each other, thereby achieving the transforming process of the two-wheeled ride-on vehicle into the three-wheeled ride-on vehicle.

The rear wheel bracket 7 is provided with a rotating block locking mechanism 72, the rear wheel rotating block 71 is provided with a plurality of rotating block gear grooves 712 corresponding to the rotating block locking mechanism 72, and the rotating block locking mechanism 72 is embedded in the rotating block gear grooves 712. The rotating block locking mechanism 72 is embedded in the rotating block gear groove 712, so that the rear wheel rotating block 71 is locked, and dangerous situations that the riding is influenced and even the riding is unstable due to the rotation of the rear wheel rotating block 71 when the rear wheel 32 is not required to be adjusted are avoided.

The rear wheel bracket 7 is provided with an arc-shaped plate 73 at a side thereof facing the rear frame 5, the arc-shaped plate 73 is embedded in the rear frame 5. The arc-shaped plate 73 is provided with a plurality of rear wheel bracket gear holes, the rear frame 5 is provided with a rear wheel bracket locking mechanism 51 corresponding to the rear wheel bracket gear holes, and the rear wheel bracket locking mechanism 51 sequentially passes through the rear wheel bracket gear holes of the arc-shaped plates 73 of the rear wheel brackets 7 located at both sides. The two rear wheel bracket gear holes are configured for a three-wheeled riding mode and a two-wheeled riding mode, respectively. After the mode conversion is carried out between the two-wheeled riding mode and the three-wheeled riding mode, the rear wheel bracket locking mechanism 51 sequentially passes through the rear wheel bracket gear holes on the arc-shaped plates 73 of the rear wheel brackets 7 located at both sides to lock gears, so that the rear wheel brackets 7 are prevented from rotating to influence the riding safety during the riding process.

The rear wheel bracket 7 is provided with a fixing slot 74. A connecting rod 75 is inserted into the fixing slots 74 of the rear wheel brackets 7 located at both sides. Both ends of the connecting rod 75 are respectively inserted into the fixing slots 74 to fix the relative position of the rear wheel brackets 7 located on both sides. The rear frame 5 is provided with an accommodating structure 52, and the accommodating structure 52 is provided with a pedal slot 521 and a connecting rod slot 522. The pedal mechanisms 4 are embedded into the pedal slot 521, and the connecting rod 75 is inserted into the connecting rod slot 522. In the two-wheeled riding mode or in the case of storage, the connecting rod 75 is taken out from the connecting rod slot 522, and both ends of the connecting rod 75 are inserted into the fixing slots 74 of the rear wheel brackets 7 located at both sides, respectively, thereby fixing the relative position of the rear wheel brackets 7 located at both sides, restricting the rotation of the rear wheel brackets 7, and improving stability. In the three-wheeled riding mode, the connecting rod 75 is taken out of the fixing slots 74, so as to open the rear wheel brackets 7 located at both sides, and achieve the conversion of the three-wheeled riding mode. The removed connecting rod 75 may be placed in the connecting rod slot 522 so as to accommodate the connecting rod 75. Similarly, the pedal mechanisms 4 can be taken out from the front wheel 31 by the clutch mechanisms 24 to convert the ride-on vehicle into a scooter, at this case, the detached pedal mechanisms 4 can be placed in the pedal slot 521 to store the pedal mechanisms 4.

In summary, according to the present disclosure, the relative position of the rear frame on the frame is adjusted, and the adjusting groove corresponding to the proper position is selected, so that the adjusting block of the rear frame is embedded into the adjusting groove, thereby achieving the adjustment of the position of the seat. When the ride-on vehicle is required to be stored, the rear frame can be moved to the corresponding position of the frame accommodating groove, so that the adjusting block is embedded in the frame accommodating groove. In addition, the rear wheel brackets located at both sides can be approached inwards, and the push rod can be removed, so as to reduce the footprint of the ride-on vehicle and facilitate storage.

The above-mentioned embodiments are merely intended for describing but not for limiting the technical schemes of the present disclosure. Although the present disclosure is described in detail with reference to the above-mentioned embodiments, it should be understood by those skilled in the art that, the technical schemes in each of the above-mentioned embodiments may still be modified, or some of the technical features may be equivalently replaced, while these modifications or replacements do not make the essence of the corresponding technical schemes depart from the spirit and scope of the technical schemes of each of the embodiments of the present disclosure, and should be included within the scope of the present disclosure.

What is claimed is:

1. A multifunctional children's ride-on vehicle, comprising:
a frame;
a vehicle head arranged at a front end of the frame;
a front wheel rotatably connected to the vehicle head;
pedal mechanisms connected to the front wheel;
a rear frame movably arranged on the frame;
a seat arranged on the rear frame;
rear wheel brackets hinged to two sides of the rear frame, respectively;
rear wheels arranged on the rear wheel brackets; and
a push rod arranged at a rear end of the frame;
wherein the frame is provided with a plurality of adjusting grooves, the plurality of adjusting grooves are evenly distributed along the frame; the rear frame is provided with an adjusting block corresponding to the adjusting groove, and the adjusting block is embedded into the adjusting grooves; the frame is provided with a frame accommodating groove at the front end thereof, and the frame accommodating groove has a size same as that of the adjusting groove.

2. The multifunctional children's ride-on vehicle of claim 1, wherein the seat is provided with an adjusting button at a bottom thereof, the adjusting button is connected with a transmission mechanism, and the transmission mechanism is connected to the adjusting block; the adjusting block is driven to be separated from the adjusting groove or the frame accommodating groove through the transmission mechanism upon pressing the adjusting button.

3. The multifunctional children's ride-on vehicle of claim 1, wherein the push rod comprises:
a telescopic rod;
a push handle arranged at a top end of the telescopic rod;
a push rod connecting block arranged at a bottom of the telescopic rod;
a frame connecting block arranged at the rear end of the frame; and
a transmission belt sleeved on the frame connecting block and the vehicle head;
wherein the push rod connecting block is embedded into the frame connecting block, the vehicle head is driven to rotate left and right through the transmission belt when the push handle is turned left and right; the telescopic rod is provided with a push rod lock, and the push rod lock is connected to the push rod connecting block.

4. The multifunctional children's ride-on vehicle of claim 1, wherein the vehicle head comprises:
a vehicle head connecting block connected to the frame;
a front handlebar passing through the vehicle head connecting block; and
a front fork connected to the front handlebar;
wherein the front handlebar and the front fork are arranged at an upper end and a lower end of the vehicle head connecting block, respectively; the front wheel is rotatably connected to the front fork, the pedal mechanisms are disposed on both ends of the front wheel passing through the front fork.

5. The multifunctional children's ride-on vehicle of claim 4, wherein the vehicle head connecting block is provided with vehicle head adjusting holes, the front handlebar is provided with a plurality of vehicle head adjusting blocks corresponding to the vehicle head adjusting holes, the vehicle head connecting block is provided with a vehicle head adjusting button corresponding to the vehicle head adjusting blocks, the vehicle head adjusting button is connected with a reset mechanism, the vehicle head adjusting block is embedded into the vehicle head adjusting hole.

6. The multifunctional children's ride-on vehicle of claim 4, wherein the pedal mechanism comprises:
a pedal;
a crank rotatably connected to the pedal; and
a connecting shaft disposed at an end of the crank;
wherein the front wheel is provided with a rotating shaft, and the connecting shaft is embedded in the rotating shaft; clutch mechanisms are provided on both sides of the front fork corresponding to the pedal mechanisms, respectively; the connecting shaft is provided with two clutch gear grooves corresponding to the clutch mechanisms, and the clutch mechanisms are embedded into the clutch gear grooves.

7. The multifunctional children's ride-on vehicle of claim 1, wherein a rear wheel rotating block is hinged on the rear wheel bracket, the rear wheel is rotatably arranged on the rear wheel rotating block, and the rear wheel rotates left and right around the rear wheel rotating block.

8. The multifunctional children's ride-on vehicle of claim 7, wherein the rear wheel bracket is provided with a rotating block locking mechanism, the rear wheel rotating block is provided with a plurality of rotating block gear grooves corresponding to the rotating block locking mechanism, and the rotating block locking mechanism is embedded in the rotating block gear grooves.

9. The multifunctional children's ride-on vehicle of claim 1, wherein the rear wheel bracket is provided with an arc-shaped plate at a side thereof facing the rear frame; the arc-shaped plate is embedded in the rear frame, the arc-shaped plate is provided with a plurality of rear wheel bracket gear holes; the rear frame is provided with a rear wheel bracket locking mechanism corresponding to the rear wheel bracket gear holes, and the rear wheel bracket locking mechanism sequentially passes through the rear wheel bracket gear holes of the arc-shaped plates of the rear wheel brackets located at both sides.

10. The multifunctional children's ride-on vehicle of claim 1, wherein the rear wheel bracket is provided with a fixing slot, a connecting rod is inserted into the fixing slots of the rear wheel brackets located at both sides; both ends of the connecting rod are respectively inserted into the fixing slots to fix a relative position of the rear wheel brackets located at both sides; the rear frame is provided with an accommodating structure, and the accommodating structure is provided with a pedal slot and a connecting rod slot; the pedal mechanisms are embedded into the pedal slot, and the connecting rod is inserted into the connecting rod slot.
